(19) United States
(12) Patent Application Publication
(10) Pub. No.: US 2008/0215786 A1
(43) Pub. Date: Sep. 4, 2008

(54) Electronic Device And A Method For Arbitrating Shared Resources

(75) Inventors: Kees Gerard Willem Goossens, Eindhoven (NL); John Dielissen, Eindhoven (NL); Andrei Radulescu, Eindhoven (NL); Edwin Rijpkema, Nieuwerkerk a/d Ijssel (NL); Paul Wielage, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,060

(22) PCT Filed: Mar. 2, 2006
(86) PCT No.: PCT/IB06/50649

§ 371 Date: Aug. 24, 2007

(30) Foreign Application Priority Data
Mar. 4, 2005 (EP) 05101716.8

(51) Int. Cl. G06F 13/36

(52) U.S. Cl. 710/243

(57) ABSTRACT

An electronic device is provided comprising a plurality of first shared resources (SR1-SR4) and a plurality of arbiter units (AAU1-AAU4) each for performing an arbitration for at least one of the plurality of shared resources (SR1-SR4). The communication between the arbiter units (AAU1-AAU4) is performed on an asynchronous basis, and the data communication between the first shared resources is performed on an asynchronous basis. Each arbiter unit (AAU1-AAU4) is adapted for sending a first token (T) to at least one neighboring arbiter unit (AAU1-AAU4), and for receiving a second token (T) from at least one neighboring arbiter unit (AAU1-AAU4) to implement a first global notion of time.

The invention relates to an electronic device and a method for arbitrating shared resources.

Among novel system on chip SoC architectures with a multi-hop interconnect, networks on chip (NOC) proved to be scalable interconnect infrastructures, composed of routers (or switches) and network interfaces (NI, or adapters), on one or more dies (“system in a package”) or chips. However, only a few of the proposed architectures offer guaranteed services (or quality of service, QoS), such as guaranteed throughput, latency, or jitter.

One example of such an architecture is the [symbol] thereal architecture with contentionfree routing or distributed TDMA as described by E. Rijpkema, K. Goossens, and P. Wielage, “A router architecture for networks on silicon”, In Proceedings of Progress 2001, 2nd Workshop on Embedded Systems, Veldhoven, the Netherlands, October 2001. A further example is the Nostrum architecture with hot-potato routing with containers as shown by M. Millberg, E. Nilsson, R. Thid, and A. Jantsch, “Guaranteed bandwidth using looped containers in temporally disjoint networks within the Nostrum network on chip”, In Proc. Design, Automation and Test in Europe Conference and Exhibition (DATE), 2004. “aSOC: A scalable, single-chip communications architecture” by J. Liang, S. Swaminathan, and R. Tessier. In Proc. Int'l Conference on Parallel Architectures and Compilation Techniques, 2000, show an aSOC with a variation on distributed TDMA.

However, these networks on chip NOCs require a global notion of synchronicity to avoid the contention of packets in the network on chip NOC by scheduling packet injection. Typically, these networks on chip have been implemented in a synchronous manner (i.e. with one global clock, either 100% synchronously or mesochronously).

Many other networks on chip NOCs have been reported without time-related (throughput, latency, jitter) Quality of Service QoS. Therefore, these do not require a global notion of synchronicity, such that their implementation may be synchronously or asynchronously. Examples are a synchronous SPIN architecture by P. Guerrier, “Un Réseau D'Interconnexion pour Systémes Intégrés”, PhD thesis, Université Paris VI, March 2000, an asynchronous router by Felicijan, Arteris's asynchronous NOC (www.arteris.net), Sonics's Silicon Backplane (www.sonicsinc.com). The synchronous implementations (e.g. SPIN and Sonics) can easily implement global arbitration schemes. The asynchronous schemes (Arteris, Felicijan) do not use a global arbitration scheme.

For an implementation of quality of service QoS, i.e. guaranteed throughput and guaranteed latency, an end-to-end arbitration is required for a multi-hop interconnect such as a network on chip. These multi-hop interconnects require multiple arbiters wherein all arbiters between a master and a slave, i.e. between a requester and a responder, have to cooperate in order to enable an end-to-end arbitration. In other words, a global notion of time is required between the master and the slave. Such a global notion of time can easily be implemented within a system on chip SOC which comprises a synchronous clock. However, a system on chip cannot be implemented 100% synchronously. This has led to an approach of a globally asynchronous, locally synchronous GALS design. In “Globally-asynchronous locally-synchronous architecture for VLSI systems” by Jens Muttersbach, Series in Microelectronics, Volume 120, Hartung—Gorre Verlag Konstanz, 2001, the basic concept of the GALS architecture is described.

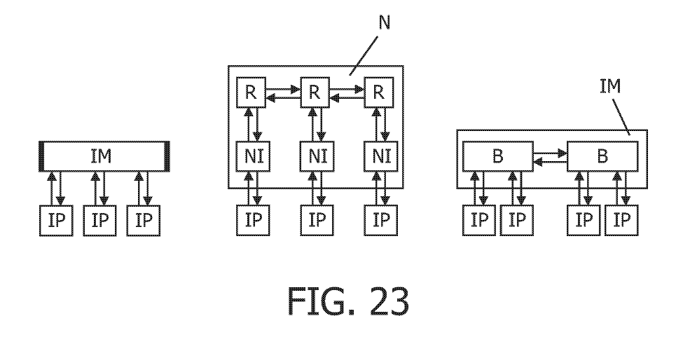

FIG. 23 shows representations of different interconnects according to the prior art. In FIG. 23a, a system on chip with three IP blocks is shown which are connected by the interconnect IM. In FIG. 23b, a multi-hop interconnect like a network on chip NOC is shown. The IP modules are coupled to the network N which comprises a plurality of routers R and network interfaces NI. In FIG. 23c, a multi-hop interconnect with multiple busses B is shown. The interconnect comprises two busses B and is coupled to the IP blocks IP.

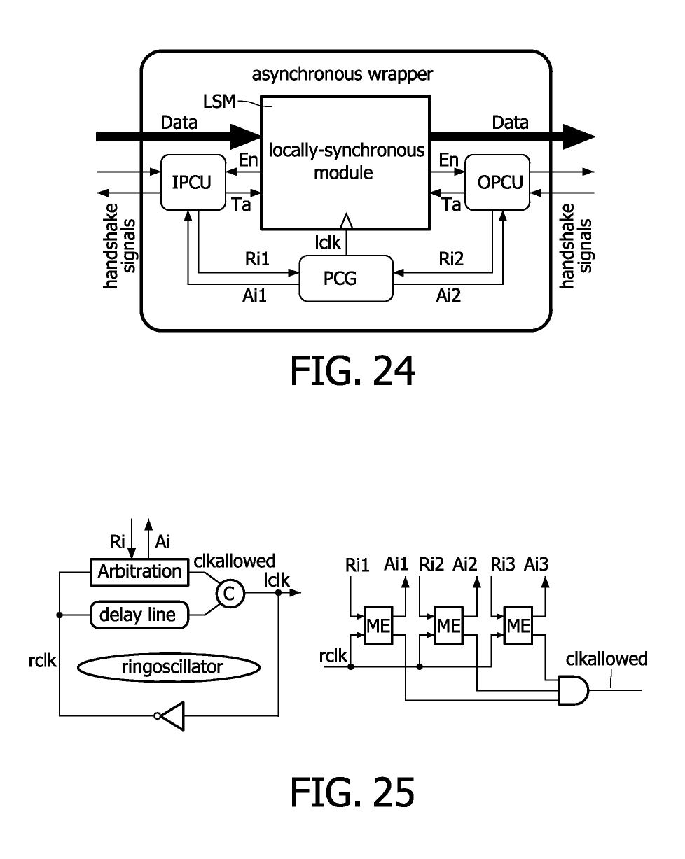

The general architecture of a GALS building block is shown in FIG. 24. It consists of an asynchronous wrapper AW around a locally synchronous module LSM (island). The wrapper AW enables the communication to the environment of the module LSM and generates the local clock for the synchronous module LSM. In the context of a network on chip NOC, the router nodes R and network interfaces NI and the IP blocks/clusters are implemented by such wrapped modules AW. The local generation of the clock allows to delay the next clock cycle when communication with the environment is in progress or is demanded. A port controller IPCU, OPCU is provided for managing all data transfers on a particular port of a block in a GALS system. It is enabled by the module LSM and serves to synchronize data transmission and local clock phases. In order to transmit data fast and efficiently, the port controllers IPCU, OPCU need to act independent from the local clock signal. This is achieved by implementing them as asynchronous finite state machines.

To cover the diverse requirement for inter-module communication, two families of port controllers are useful, namely a poll-type and a demand-type port. A Poll-type (P-type) port issues the request for clock stretching exclusively to prevent metastability and thus ensures data correctness. The clock is influenced as scarce as possible. A Demand-type (D-type) port also ensures data integrity on the transfer channel but adds a feature similar to clock gating. As soon as it is enabled it stops the local clock and releases it as soon as the required transfer has taken place.

Furthermore, an implementation of the port types in an input and output variant is shown in FIG. 24. These port controllers have two handshake pairs: one between the controller and the clock generator, and one between controller and corresponding module. They employ four-phase handshaking (level-signaling). Furthermore, the port enable line employs a two-phase protocol (transition signaling). Ta is the acknowledge signal from the port controller to the LS module. Its level indicates whether the transfer of a data-word has occurred.

In FIG. 25 a block diagram of a pausable clock generator of FIG. 24 is shown. The pausable clock generator PCG is a crucial element of a GALS module. Here, an implementation, without any measures for test and debug, is shown.

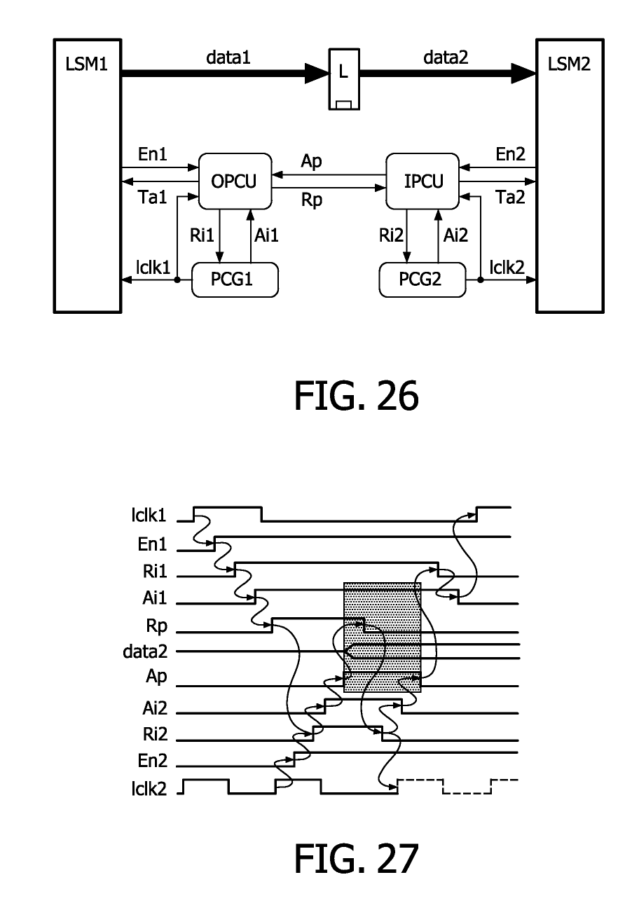

FIG. 26 shows the implementation of a unidirectional channel between two locally synchronous islands (LSM1, LSM2) according to the prior art. The handshake protocol as described above is assumed. The connection between the port controllers PCU is established via the handshake signals Ap and Rp. The latches L on the data lines data1, data2 that are controlled by the handshake acknowledge signal Ap decouple the communicating modules LSM1, LSM2 as much as possible. Adding memory to the transfer channel allows the sender to resume operation although the receiving clock has not yet sampled the data.

FIG. 27 shows the waveforms of a data transfer from a D-output to a P-input. In the beginning the D-output gets enabled, stops its clock and issues Rp+. At this time the receiving port has not yet been enabled. As soon as this happens it detects the pending handshake, stops its clock and acknowledges the handshake. After the external handshake has been processed, both ports and their corresponding modules LSM may resume their operation.

The gray shaded area marks the transparent phase of the data latches L (Ap=1). At the time the latch L opens the receiving clock is inactive (Ai2=1) and remains inactive far longer then than the propagation delay of the latch. This ensures that the events on the data lines arrive at the receiving flip-flops safely and no metastability can occur. Keeping the sending clock stopped (Ai1=1) assures that data1 do remain stable while the latches are transparent.

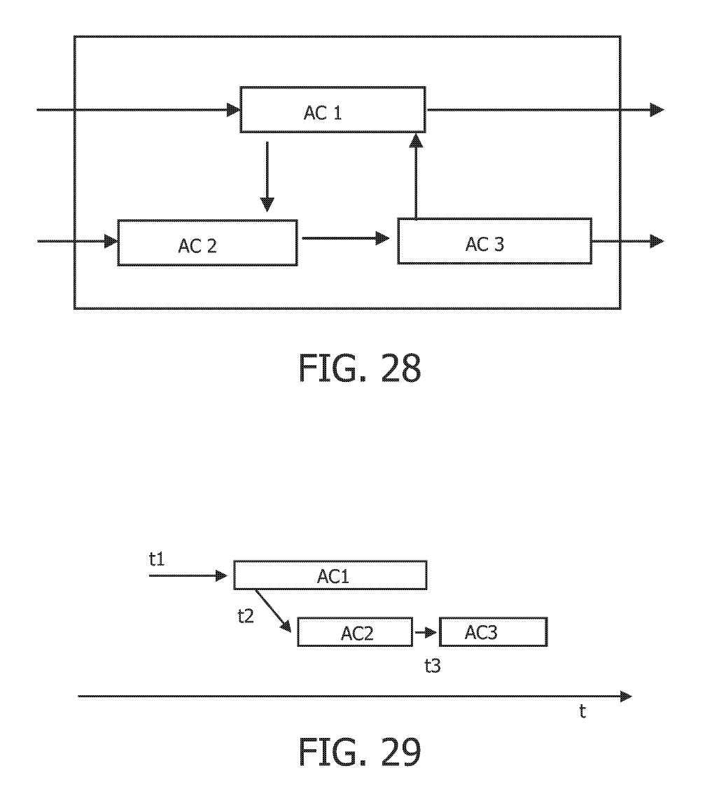

FIG. 28 shows a block diagram of a conventional asynchronous system on chip. Three asynchronous circuits AC1-AC3 are depicted. Each of the asynchronous circuits AC1-AC3 is activated only when data is actually present on at least one of its inputs. Accordingly, the asynchronous circuits AC1-AC3 do not have any notion of time or do merely have their own local notion of time.

FIG. 29 shows an execution trace of the conventional asynchronous system with the three asynchronous circuits AC1-AC3. Here, the asynchronous circuits AC1-AC3 are individually as well as independently triggered without any notion of time. At t1 the input for the circuit AC1 arrives at the first circuit AC1. At t2 the input for the second circuit AC2 arrives from the first circuit AC1. At t3 the input for the third circuit AC3 arrives from the second circuit AC2.

It is an object of the invention to provide an electronic device and a corresponding method for implementing Quality of service in the absence of a global synchronous clock.

This object is solved by an electronic device according to claim 1, a method for arbitrating shared resources according to claim 18, and the use of tokens to communicate a notion of time between arbiter units according to claim 19.

Therefore, an electronic device is provided comprising a plurality of first shared resources; and a plurality of arbiter units each for performing an arbitration for at least one of the plurality of first shared resources. The communication between the arbiter units is performed on an asynchronous basis, and the data communication between the first shared resources is performed on an asynchronous basis. Each arbiter unit is adapted for sending a first token to at least one neighboring arbiter unit, and for receiving a second token from at least one neighboring arbiter unit to implement a first global notion of time.

Hence, the proposed global arbitration scheme is scalable in the number of arbitration units, which is an advantage over the use of a synchronous communication between the arbitration units which is not scalable.

According to an aspect of the invention the electronic device further comprises a plurality of ports and an asynchronous interconnect means being a first shared resources for coupling the plurality of ports. The interconnect means comprises a plurality of interconnect units each being a second shared resource and a plurality of arbiter units for performing an arbitration for at least one of the plurality of second shared resources and for sending a first token to at least one neighboring interconnect component, and for receiving a second token from at least one neighboring interconnect component to implement a second global notion of time within the interconnect means. Accordingly, the global notion of time can also be realized in the interconnect allowing an implementation of quality of service within an asynchronous interconnect and hence between the ports

The invention further relates to a method for arbitrating shared resources within an electronic device having a plurality of first shared resources. A plurality of arbitrations for at least one of the plurality of first shared resources is performed. The communication between arbitrations is performed on an asynchronous basis. The data communication between the first shared resources is performed on an asynchronous basis. Each arbitration comprises a step of sending a first token to at least one neighboring arbitration, and of receiving a second token from at least one neighboring arbitration to implement a first global notion of time.

The invention further relates to the use of tokens to communicate a notion of time between arbiter units for performing a plurality of arbitrations for at least one of a plurality of first shared resources in an electronic device. The communication between the arbitration units is performed on an asynchronous basis. A data communication between the first shared resources is performed on an asynchronous basis. This is advantageous as tokens usually merely communicate data and not time.

The invention is based on the idea to provide an asynchronous implementation of a distributed global arbitration schemes (e.g. memory controller and network on chip NOC arbitration scheme, communication assist and network on chip NOC arbitration scheme in a tile-based approach). A global notion of synchronicity (or arbitration scheme) is provided which can be implemented asynchronously in a distributed fashion. It can applied to implement networks on chip NOCs (or, more generally communication infrastructures, such as hierarchical/bridged busses) with other arbitration schemes that require a global notion of synchronicity too, such as rate-controlled schemes (e.g. virtual-circuit-queued or output-queued) and deadline based schemes. Fundamentally, the basic idea is that a network on chip NOC can implement global notion of synchronicity (or a global schedule) by being made up of components (e.g. routers, network interfaces) that exchange tokens every logical unit of synchronization (or time step or data flow firing).

The invention is preliminary directed to the case of a) an asynchronous network on chip NOC coupling IP blocks at multiple or divisor of network on chip NOC synchronization rate, i.e. demand-driven; b) an asynchronous network on chip NOC coupling IP blocks IP which do not operate at multiple or divisor of network on chip NOC synchronization rate, i.e. are data-driven; and c) an asynchronous network on chip NOC coupling IP blocks IP which do not operate at multiple or divisor of network on chip NOC synchronization rate, i.e. are event-driven.

Further aspects of the invention are described in the dependent claims.

These and other aspects of the invention are apparent from and will elucidated with reference to the embodiments described hereinafter and with respect to the following figures.

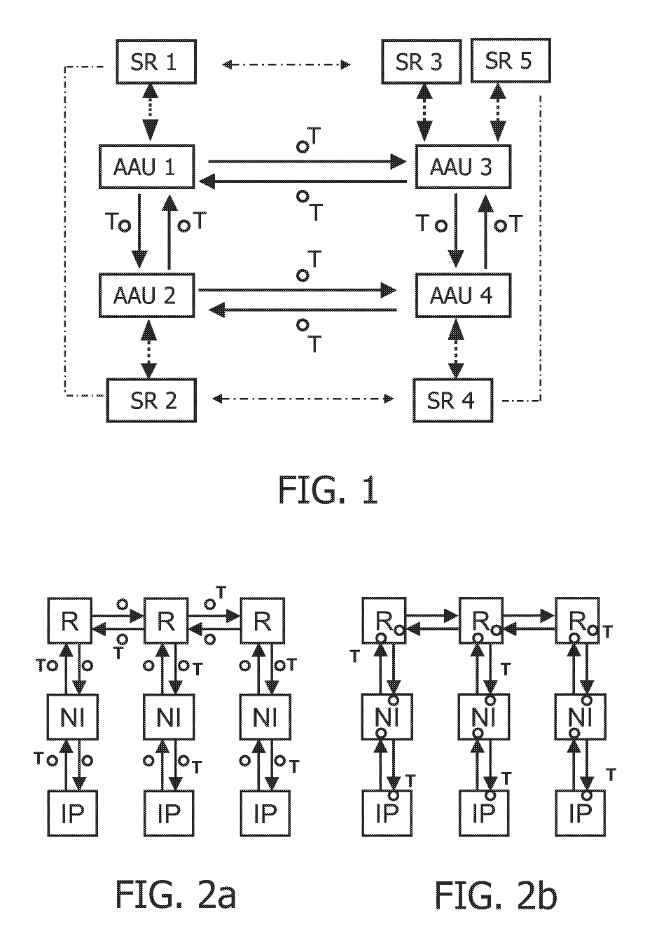

FIG. 1 shows a block diagram of an asynchronous system according to a first embodiment of the invention;

FIG. 2 show block diagrams of a multi-hop interconnect coupling several IP blocks according to a first embodiment;

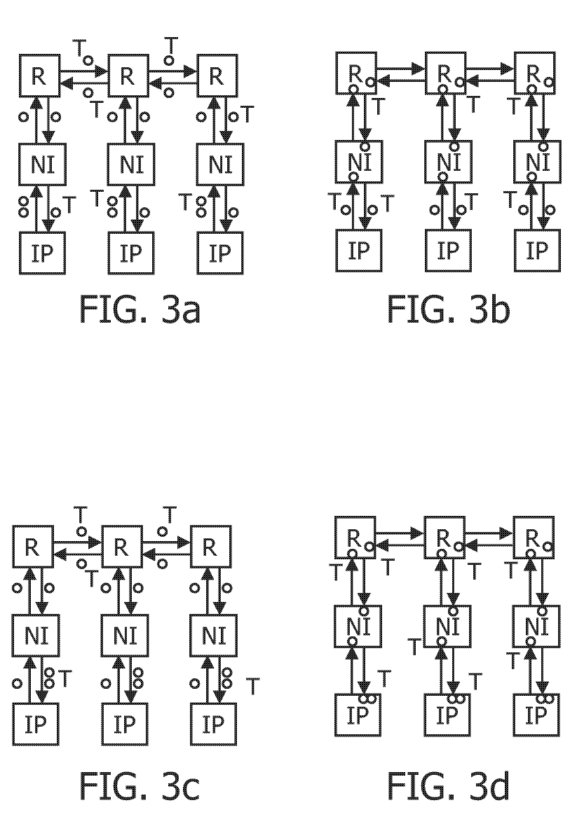

FIG. 3a-d shows a network on chip with routers R and network interfaces NI as interconnects as well as IP blocks;

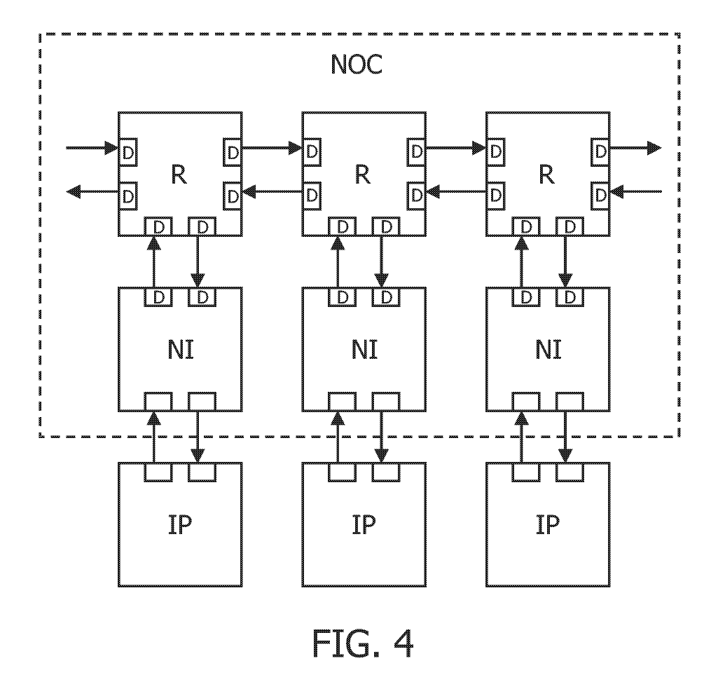

FIG. 4 shows a block diagram of a network on chip NOC for coupling three IP blocks IP according to the second embodiment;

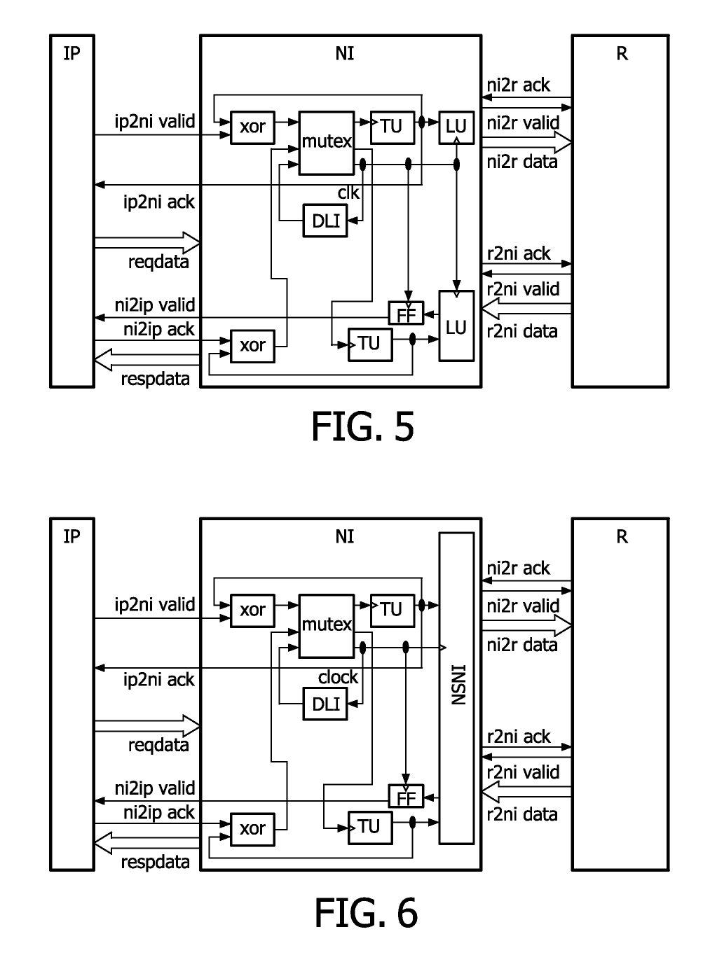

FIG. 5 shows a block diagram of an IP block IP, a network interface NI and a router R;

FIG. 6 shows a block diagram of an IP block IP, a network interface NI and a router R according to FIG. 5;

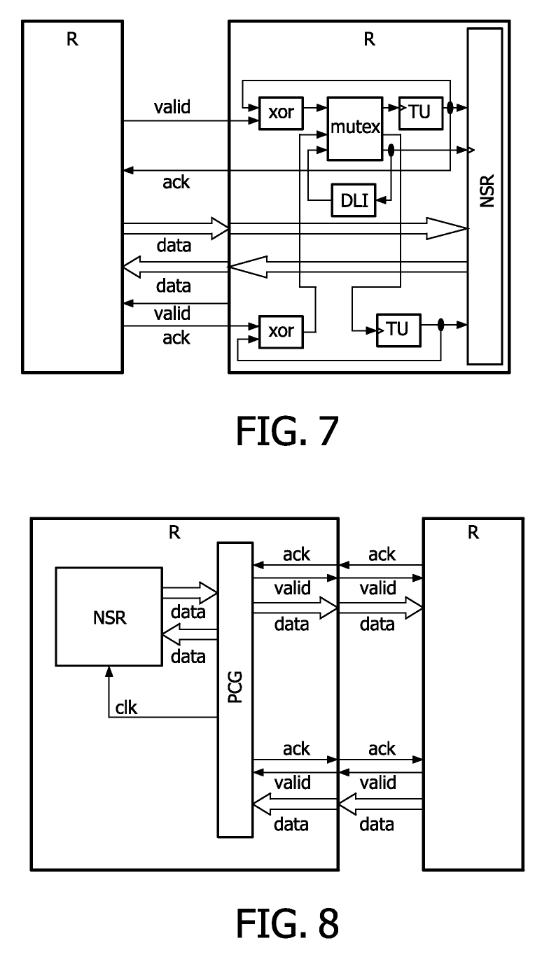

FIG. 7 shows a more detailed block diagram of two neighboring routers of FIG. 4;

FIG. 8 shows a further detailed block diagram of two neighboring routers of FIG. 4;

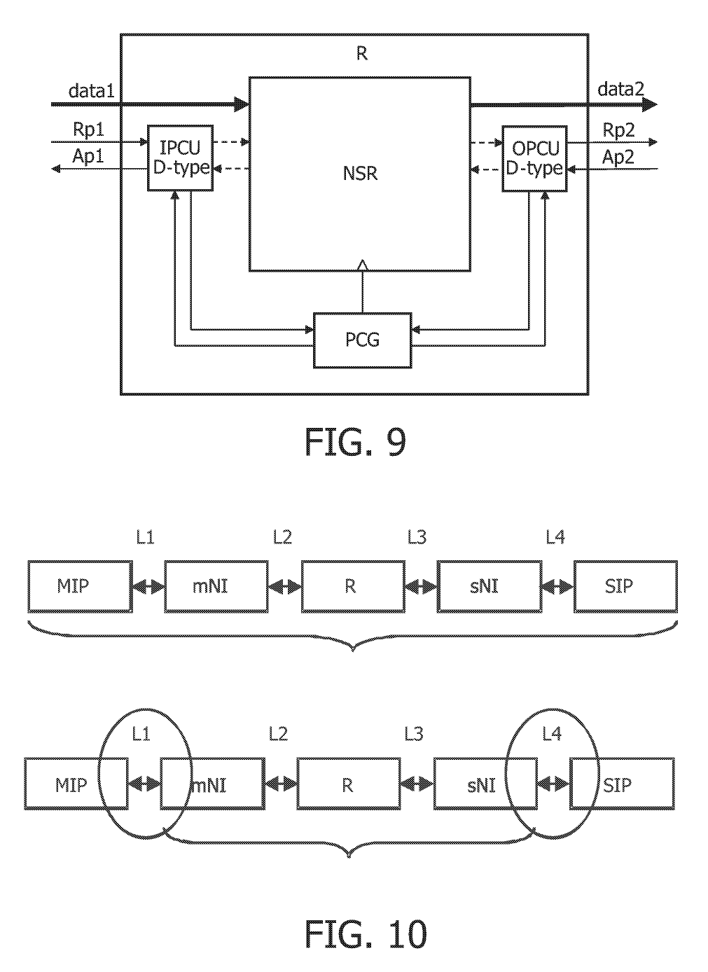

FIG. 9 shows a block diagram of a router R of FIG. 4 according to the second embodiment.

FIG. 10 shows a block diagram of a part of the network on chip;

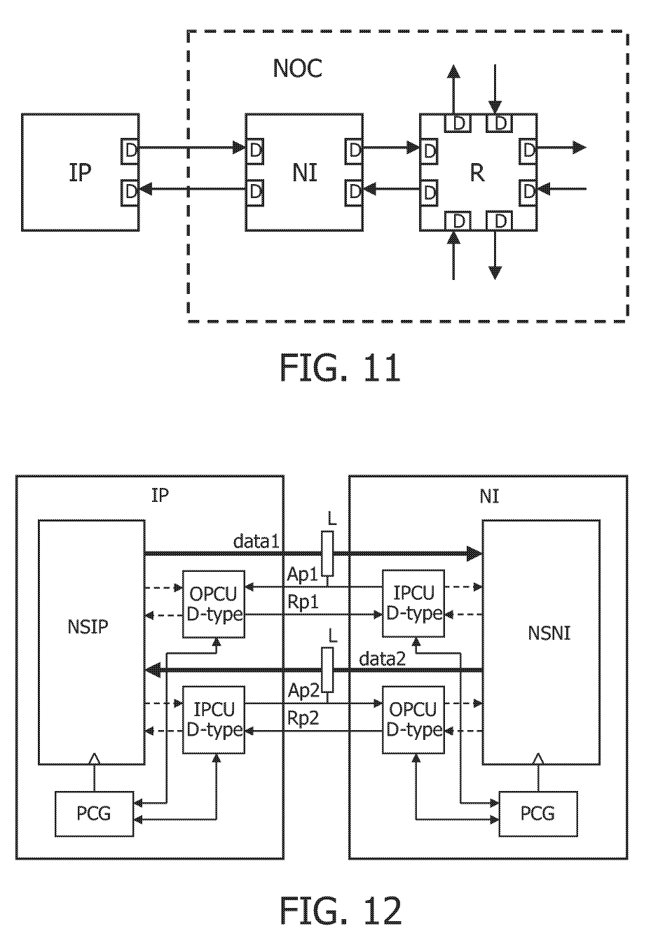

FIG. 11 shows a block diagram of part of a network on chip according to the third embodiment;

FIG. 12 shows a more detailed block diagram of the IP block IP and the network interface NI;

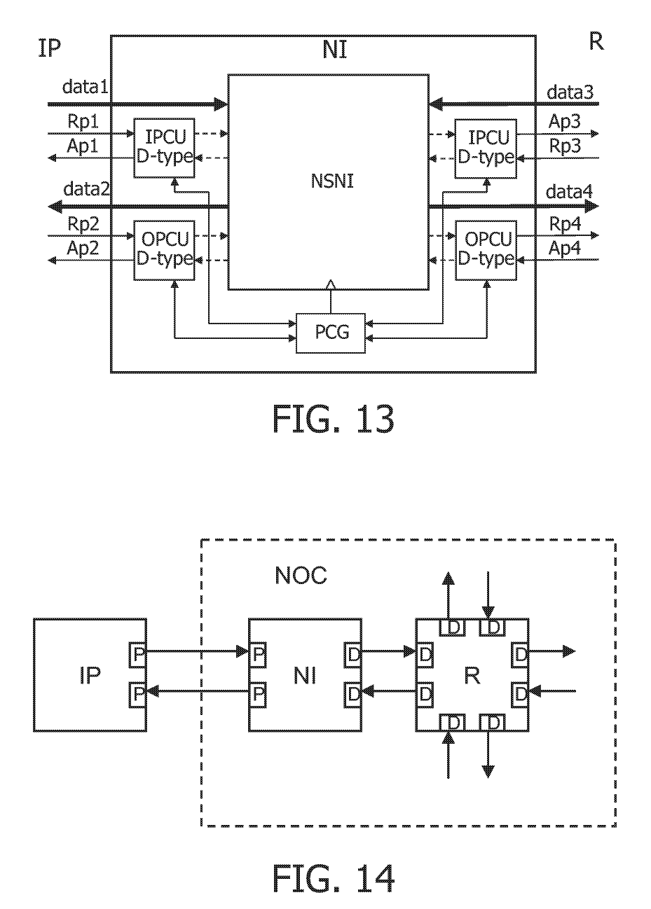

FIG. 13 shows a more detailed block diagram of a network interface of FIG. 4;

FIG. 14 shows a block diagram part of a network on chip according to a fourth embodiment;

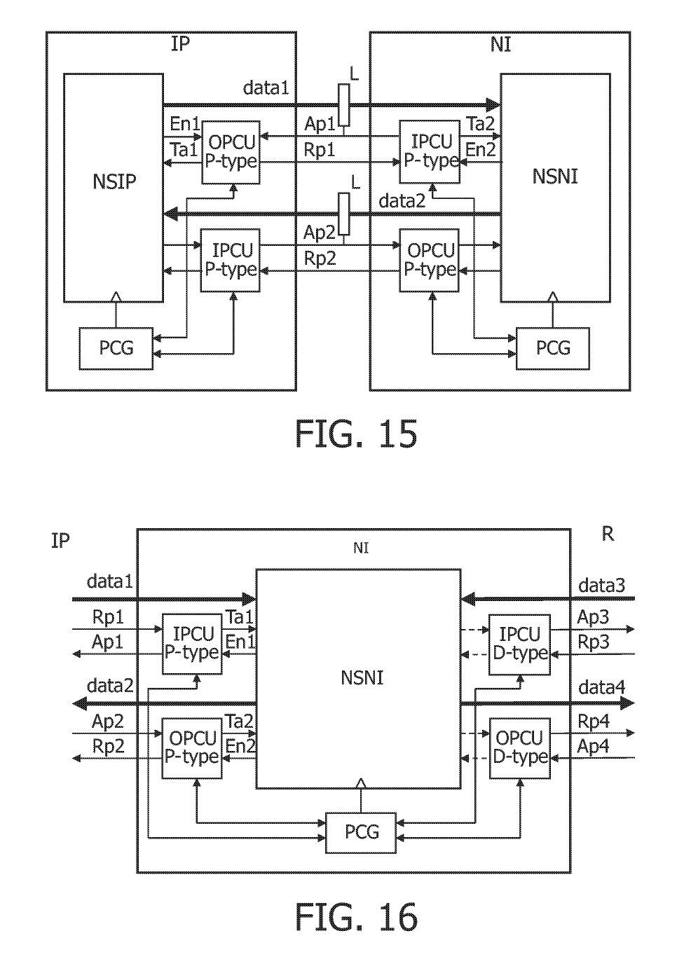

FIG. 15 shows a more detailed block diagram of the IP block IP and the network interface according to FIG. 14 according to the fourth embodiment

FIG. 16 shows a more detailed block diagram of a network interface of FIG. 14;

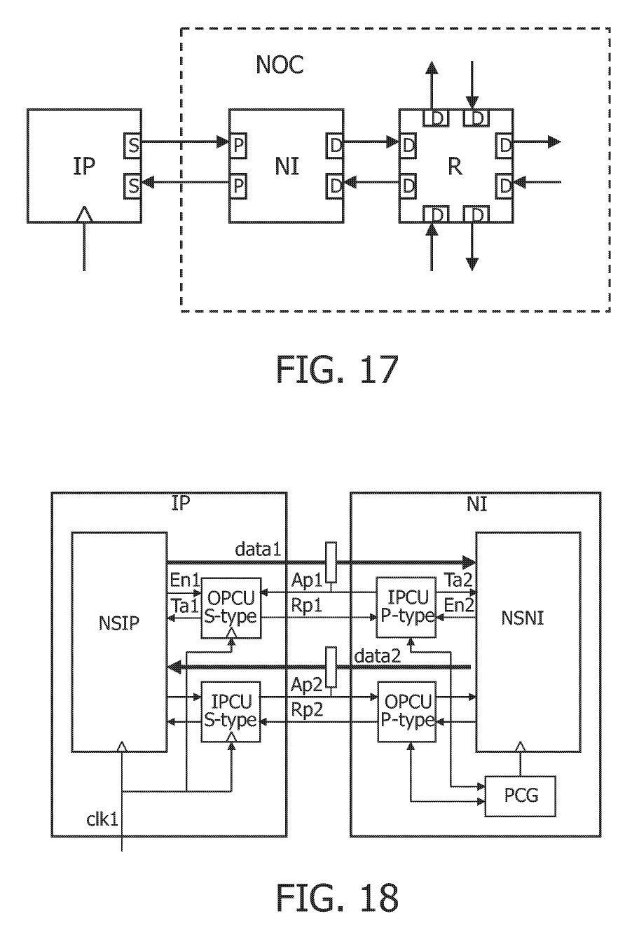

FIG. 17 shows a block diagram of part of a network on chip coupled to an IP block according to the fifth embodiment;

FIG. 18 shows a more detailed block diagram of the IP block IP and the network interface NI of FIG. 17;

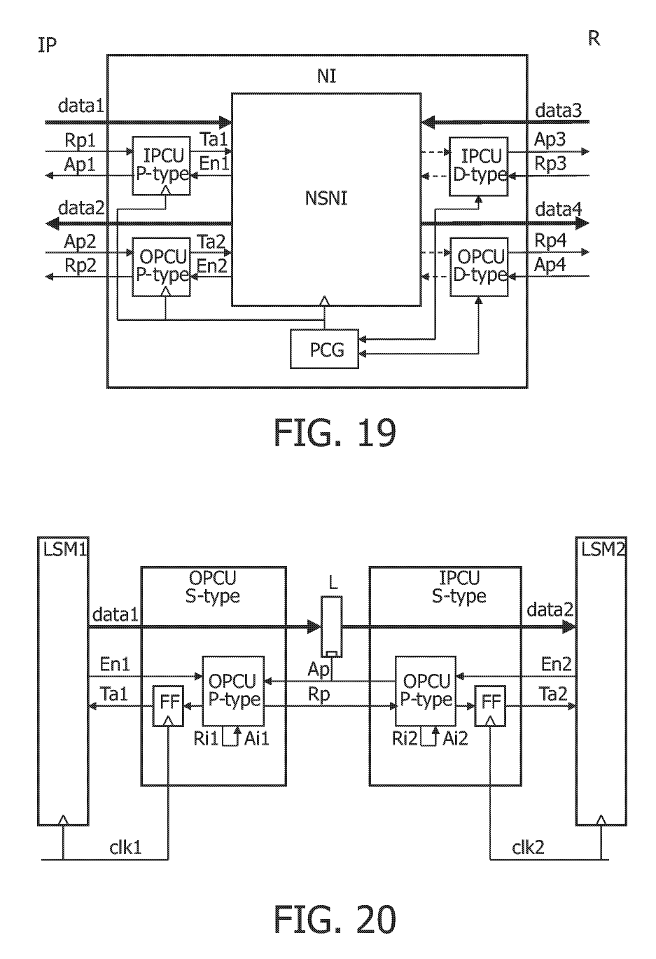

FIG. 19 shows a more detailed block diagram of a network interface of FIG. 17;

FIG. 20 shows a block diagram of an implementation of a unidirectional channel between two locally synchronous islands (LSM1, LSM2) according to a seventh embodiment;

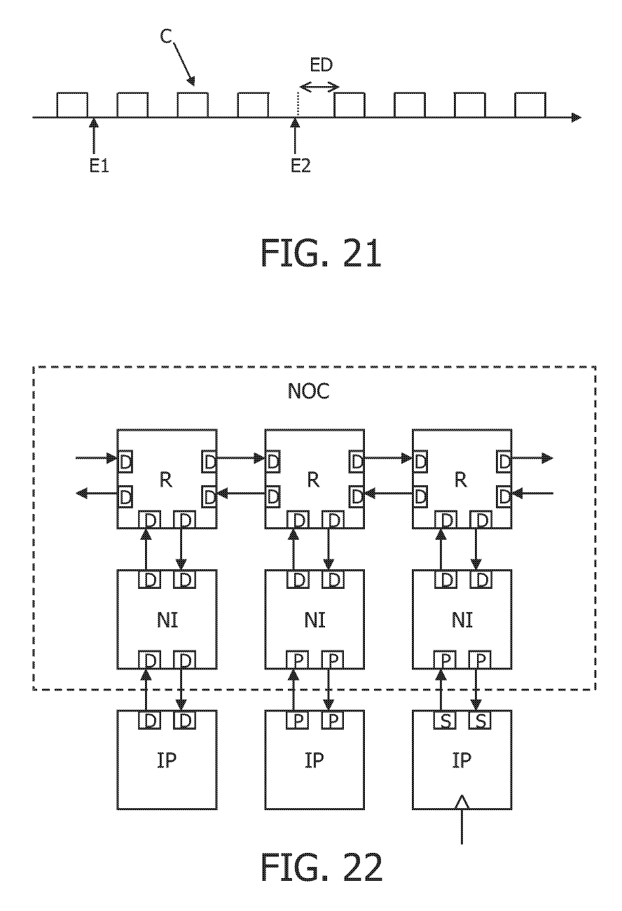

FIG. 21 shows a representation of the timing signals for an event driven synchronization;

FIG. 22 shows a network on chip coupling several IP blocks according to a sixth embodiment;

FIG. 23 shows representations of different interconnects according to the prior art;

FIG. 24 shows a general architecture of a GALS building block;

FIG. 25 shows a block diagram of a pausable clock generator of FIG. 24;

FIG. 26 shows the implementation of a unidirectional channel between two locally synchronous islands according to the prior art;

FIG. 27 shows the waveforms of a data transfer from a D-output to a P-input;

FIG. 28 shows a block diagram of a conventional asynchronous system on chip; and

FIG. 29 shows an execution trace of the conventional asynchronous system with the three asynchronous circuits.

The present method of providing QoS (in particular bounded latency) consists in the data-flow model underlying contention-free routing, as documented in E. Rijpkema, K. Goossens, and P. Wielage, “A router architecture for networks on silicon”, In Proceedings of Progress 2001, 2nd Workshop on Embedded Systems, Veldhoven, the Netherlands, Oct. 2001. The logical unit of synchronization can be a flit, as explained by E. Rijpkema, K. G. W. Goossens, A. Radulescu, J. Dielissen, J. van Meerbergen, P. Wielage, and E. Waterlander, “Trade offs in the design of a router with both guaranteed and best-effort services for networks on chip”, In Proc. Design, Automation and Test in Europe Conference and Exhibition (DATE), pages 350-355, March 2003. This scheme can be implemented on a synchronous basis, as explained in cited papers, but also to asynchronous implementation according to the invention.

FIG. 1 shows a block diagram of an asynchronous system according to a first embodiment of the invention. The system comprise several shared resources SR1-SR4 and several arbiter units AAU1-AAU4. The inter arbiter communication, i.e. the communication between the arbiters, is performed asynchronously among. The shared resources SR1-SR4 may communicate data between themselves. Each of the arbiter units AAU1-AAU4 activates when a token T is present on its inputs. Accordingly, the asynchronous arbiters AAU1-AAU3 have a global and shared notion of time. As a result the arbiters units AAU can arbitrate—see dashed lines—shared resources associated to the arbiter units. In particular, arbiter unit AAU1 is associated to and arbitrates the shared resource SR1. The arbiter unit AAU2 is associated to and arbitrates shared resource 2. The arbiter unit AAU3 is associated to and arbitrates shared resources SR3 and SR5. The arbiter unit AU4 is associated to and arbitrates shared resource 4. The arbitration of the arbiter units AU1-AU4 is preformed in a globally synchronised or concerted fashion. The shared resources SR1-SR4 may communicate data between themselves. The arbiter units AAU1-AAU4 merely communicate with neighbouring arbiter units to implement the global notion of time. Hence, the proposed global arbitration scheme is scalable in the number of arbitration units, which is an advantage over the use of a synchronous communication between the arbitration units which is not scalable.

The global notion of time describes a situation where an (possibly every) arbiter unit is aware of the state or status of (all) other arbiter units. Therefore, if an arbiter unit is in step 3, all the other arbiter will also be in step 3.

FIGS. 2(a) and 2(b) show block diagrams of a multi-hop interconnect IM coupling several IP blocks according to a first embodiment. The interconnect IM comprises several routers R and network interfaces NI as interconnect component or interconnect node for connecting the routers to the IP blocks IP.

An asynchronous implementation of a router R (or other network on chip NOC component) result, upon start up/reset, firstly in a production of a token T on every output, i.e. each link to other network on chip NOC components as shown in FIG. 2a, and then (forever, or until reset) read a token from every input, process the tokens as shown in FIG. 2b, and then produce a token T on every output. In this way all routers advance in lock step, e.g. to be in the same TDMA slot. This has the effect of implementing a global arbitration scheme with only asynchronous handshakes to neighbors, who tend to be local. Producing and consuming tokens corresponds to a demand-driven (request-acknowledge) style of interaction (handshakes).

This concept can be used for rate-controlled and dead-line based global arbitration schemes too. Note that the tokens T either contain data or are empty. Even in the absence of data they must be sent to maintain the notion of synchronicity.

Now the implementation of Quality of service for an asynchronous interconnect IM is described. The network on chip NOC components will advances as slowly as the slowest component, constituting the synchronization rate of the network on chip NOC as a whole. The number of iterations per second is related to the “actual clock speed.” For example, a synchronization step may correspond to three clock cycles. The fact that the synchronization rate is generated internally in the network on chip NOC, i.e. by the slowest component, and not imposed by an external known clock (as is the case for fully synchronous networks on chip NOCs) is not problematic, and does not invalidate the concept of QoS because all asynchronous components within the network are designed with a certain target frequency of operation in mind.

As an example for illustration, the target frequency may be 166 M synchronizations/sec or 166 Mega flits/sec; where a flit may be 3 words of 32 bits each. By taking the appropriate margin (or “over-designing”), by 20% for instance, the components should run at 200M synchronizations/sec or 200 M flits/sec, but the slowest component will surely run faster than the intended 166M synchronizations/sec or 500 M words/sec, leading to a guaranteed throughput of at least 166M synchronizations/sec or 500 M words/sec, and a potentially faster operating network on chip NOC. The actual margin will depend on the accuracy of chip processing, worst-case operating conditions, and so on. This line of reasoning is accepted equally for synchronous and asynchronous modules/ICs.

FIG. 3a-d shows a network on chip with routers R and network interfaces NI as interconnects as well as IP blocks IP coupled to the respective network interfaces NI according to a second embodiment. The IP blocks may operate at multiple rates (or divisor rates) using different token rates. Accordingly, Quality of Service (QoS) of an asynchronous multi-hop interconnect IM with the IP blocks IP running at multiples or divisors of network on chip NOC synchronization rate are shown. In FIG. 3a the IP blocks IP run at the double rate of the interconnect and therefore produce two synchronization tokens T while the routers R and the network interfaces NI merely produce a single token T.

In both cases, the solution is only applicable for IP blocks running at multiples or divisors of the network on chip NOC frequency. Moreover, in the synchronous case, it is no longer feasible to have a single synchronous clock serving all IP blocks attached to a network on chip NOC.

In the synchronous case, the use of multiple independent clocks for IP and network on chip NOC (which operates on one clock) relies on data synchronization, i.e. the use of two flip-flops in series to cross from one clock domain (of the IP) to another (that of the network on chip NOC), or vice versa. This can be referred to as data-driven synchronization. Although such a solution will work, it is not optimal because errors may occur when sampling data coming from another clock domain. This situation gets worse as both frequencies increase.

In the asynchronous case, the synchronization of multiple independent clocks for the IP and network on chip NOC which operates with a logical notion of synchronicity, can be solved by demand-driven synchronization, data synchronization or by event-driven synchronization. The first solution cannot cope with all clock ratios, variable clocks, etc. The second solution introduces the potential for incorrect data. The third solution has neither problem.

In the case of data driven synchronization every module, on every of its communication lines to other modules, samples the lines when it advances its clock. This can be done with the double flip-flop scheme. Potential problems with incorrect data samples are introduced. In particular, there is a probability that a bit which is sampled using the two flip-flops is incorrect. By using more flip-flops this probability can be reduced, at the cost of an increased latency. Now note that for every data-driven port/link on the system this error probability exists, and that these probabilities add up, in the sense that errors do not cancel each other out or compensate for each other.

A demand-driven synchronization is shown in FIG. 2 and FIG. 3 and constitutes an embodiment between network on chip NOC modules (NI and routers). No errors will occur in the data that is transmitted.

FIG. 4 shows a block diagram of a network on chip NOC for coupling three IP blocks IP according to the second embodiment. The network on chip comprises three network interfaces NI as well as three routers R. The routers R as well as the network interfaces NI communicate via D-type ports D.

FIG. 5 shows a block diagram of an IP block IP, a network interface NI and a router R. The interface between IP block IP and the network interface NI is implemented based on a plausible clock scheme while the interface between the network interface NI and the router R is implemented based on a demand driven synchronization. The communication from the IP block IP to the network interface NI is implemented by a request signal ip2ni_valid from the IP block and a response signal ip2ni_ack from the network interface together with the request data reqdata. The communication from the network interface NI to the IP block IP is implemented by a request signal ni2ip_valid from the network interface NI and a response signal ni2ip_ack from IP block IP together with the respond data respdata. Furthermore, the communication from the network interface NI to the router R is implemented by a request signal ni2r_valid from the network interface NI and a response signal r2ni_ack from the router R together with the data ni2r_data. The communication from the router R to the network interface NI is implemented by a request signal r2ni_valid from the router and a response signal r2ni_ack from network interface together with the data r2ni_data.

The network interface NI comprises an exclusive OR unit XOR, connected to a mutual exclusion unit mutex, which in turn is connected to a toggle unit TU. The output of the toggle unit TU is connected to a logic unit LU and constitutes the response signal ip2ni_ack. A feed back loop with a delay line and inverter DLI is coupled to the mutual exclusion unit mutex. The two input mutual exclusion element mutex is a standard asynchronous building blocks.

The response part of the network interface NI is arranged in a corresponding manner without the delay and inverter DLI.

Basically, whenever an external event from the IP arrives at the NI a state element is toggled to store this information (that the IP has communicated) so that it can be used by the logic block. The event is then acknowledged by the signal ip2ni_ack to the IP block IP. The acknowledge to the IP block is in the critical path and must be as quick as possible. For this reason the toggle element TU lowers the request line (going into the mutual exclusion element), immediately, without requiring any interaction from the potentially very slow IP block. The IP block can then respond to the acknowledge at leisure. The logic unit LU uses the information that the request line ip2ni_valid has been high, e.g. to read out the request data.

FIG. 6 shows a block diagram of an IP block IP, a network interface NI and a router R according to FIG. 5. However, according to FIG. 6 a synchronous NI core NSNI can be re-used. The other arrangement of FIG. 6 corresponds the arrangement of FIG. 5. In other words, if an asynchronous network interface is to be implemented this can be achieved by using the typical structure of a synchronous network interface and to provide a kind of internal shell to enable the communication to the IP block IP on top of such a typical structure.

It should be noted that the above mentioned operations normally do not stop the internally generated clock of the NI at all.

FIG. 7 shows a more detailed block diagram of two neighboring routers of FIG. 4. The interface between routers R is implemented based on a demand-driven synchronization. The communication between the routers is implemented by a request signal valid and a response signal ack together with the request data data.

The router comprises an exclusive OR unit XOR, connected to a mutual exclusion unit mutex, which in turn is connected to a toggle unit TU. The output of the toggle unit TU is connected to a synchronous router core NSR. A feed back loop with a delay line and inverter DLI is coupled to the mutual exclusion unit mutex. The two input mutual exclusion element mutex is a standard asynchronous building blocks.

FIG. 8 shows a further detailed block diagram of two neighboring routers of FIG. 4. The router comprises a normal synchronous router core NSR as well as a pausable clock generator PCG.

FIG. 9 shows a block diagram of a router R of FIG. 4 according to the second embodiment. The router R will comprise demand-driven interfaces coupling the router R to the neighboring routers R and possibly to neighboring network interfaces NI. The router R comprises a normal synchronous router NSR as core with an input port controlling unit IPCU and an output port controlling unit OPCU. The input port controlling unit IPCU as well as the output port controlling unit OPCU are implemented as D-type ports. The two port controlling units IPCU, OPCU are coupled to a pausable clock generator PCG. The communication between the router R and a neighboring router is performed on its input side the handshake signals AP1 and RP1, and the router receives input data data1. On the output side of the router R, the communication to a neighboring router R is performed via the handshake signals AP2 and RP2, and data data2 is forwarded to the subsequent router.

In the upper part FIG. 10 a block diagram of a part of the network on chip is shown. FIG. 10 shows part of the network on chip according to a second embodiment. Here, a master IP block MIP (acting as master), a master network interface mNI, one or more routers R, a slave network interface and a slave IP block SIP (acting as slave) are shown. These units are connected by links L1, L2, L3, L4 which are logically synchronous, i.e. are in the same clock domain or synchronize at a fixed rate. In other words, the IP blocks MIP, SIP as well as the interconnects mNI, R, sNI are logically synchronous. Any time-related QoS can extend from the master IP block MIP to the slave IP block SIP.

FIG. 10 shows in its lower part the same part of the network on chip, but here only the interconnect IM, the master network interface mNI, the router R and the slave network interface sNI are logically synchronous. Any time-related QoS will extend from the master network interface MNI to the slave network interface SNI, i.e. not from the master IP block MIP to the slave IP block SIP as the links L1 and L4 are not synchronous. The data for the communication over these links L1, L4 must be sampled to enable a data-driven synchronization or the respective clocks must be synchronized to enable an event-driven synchronization.

Now the interaction between a network on chip NOC (synchronous or asynchronous) and the IP blocks is considered. The QoS (e.g. guaranteed latency) as implemented by the network on chip NOC will only stretch from the master mNI to the slave mNI. If the master (slave) and network on chip NOC (i.e. master (slave, resp) NI) operate synchronously, i.e. within the same or derived clock domain (i.e. without clock domain crossing), then the QoS guarantees will extend from the master to the slave. Similarly, if the network on chip NOC is asynchronous, and the master (slave) synchronizes every (fixed multiple) time step with the master (slave, resp) NI, the QoS will extend from the master MIP to the slave SIP. Accordingly, this will correspond to an asynchronous (multi-rate SDF) situation, i.e. a demand-driven synchronization.

In FIG. 11, a block diagram of part of a network on chip according to the third embodiment is shown. Please note that for illustrating the invention only one IP block IP, one network interface NI as well as merely one router R are shown. The communication between the IP block IP and the network interface is performed via a D-type interface with D-type ports D in the IP block IP as well as in the network interface NI. The communication between the network interface NI and its associated router R is performed as well based on a D-type interface with D-type ports D. The same applies for the inter-router communication. Accordingly, a demand-driven communication is shown between the network on chip NOC and the IP block IP. Here, the IP block performs its processing on the same or on multiple-divisor rate of the network on chip.

In FIG. 12, a more detailed block diagram of the IP block IP and the network interface NI is shown. The IP block IP comprises a normal synchronous IP core NSIP. An input port controlling unit IPCU as well as an output port controlling unit OPCU is coupled to the normal synchronous IP unit NSIP port controlling units OPCU and IPCU. Both are implemented as D-type ports. The port controlling units are coupled to a pausable clock generator PCG. The network interface NI comprises a normal synchronous network interface core NSNI with an input port controlling unit IPCU as well as an output port controlling unit OPCU. The port controlling units are both coupled to a pausable clock generator PCG. The communication from the IP block to the network interface NI is handled via the handshake signals AP1 and RP1 with data data1 being transferred from the IP block IP to the network interface NI. The communication from the network interface to the IP block is controlled via the second handshake signals AP2 and RP2 with data data2 being transferred from the network interface NI to the IP block IP. Accordingly, a demand-driven interface is implemented between the IP block IP and the network interface NI.

FIG. 13 shows a more detailed block diagram of a network interface of FIG. 11. The network interface comprises both demand-driven interfaces to the IP and Router which are implemented as D-type ports.

FIG. 14 shows a block diagram part of a network on chip according to a fourth embodiment. The basic structure of the network on chip corresponds to the structure according to FIG. 11. However, the interface between the IP block IP and the network interface NOC is a P-type interface. Therefore, the IP block comprises two P-type ports and the network interface NI also comprises two P-type ports. The communication between the network interface and the router as well as the inter-router communication is based on D-type interfaces with D-type routers.

FIG. 15 shows a more detailed block diagram of the IP block IP and the network interface according to FIG. 14 according to the fourth embodiment. The basic structure of the IP block and the network interface of FIG. 15 corresponds to the structure of the network interface and the IP block according to FIG. 12. However, the port controlling units OPCU and IPCU are implemented as a P-type port controlling unit such that a P-type interface is being implemented between the IP block and the network interface. Accordingly, an event-driven interface is implemented between the IP block IP and the network interface NI. The communication from the IP block to the network interface is controlled via the first handshake signals AP1 and RP1 with data data1 and the communication from the network interface to the IP block is controlled via the second handshake signals AP2 and RP with data data2 being transferred from the network interface NI to the IP block IP

FIG. 16 shows a more detailed block diagram of a network interface of FIG. 14. The network interface comprises one event-driven interface (for communication to the IP) and a demand-driven interfaces (for communication to the router) which are implemented as P-type port and D-type ports, respectively.

FIG. 17 shows a block diagram of part of a network on chip coupled to an IP block according to the fifth embodiment. The structure of the network on chip and the IP block corresponds to the structure of FIG. 11 and FIG. 14. The communication between the network interface NI as well as the inter-router communication is based on D-type interfaces with D-type ports. However, the communication between the IP block and the network interface is performed with a data-driven interface, wherein the IP block comprises S-type ports and the network interface comprises P-type ports. Here, the IP block may run at a rate which is independent of the rate of the network on chip.

FIG. 18 shows a more detailed block diagram of the IP block IP and the network interface NI of FIG. 17. The basic structure of the IP block as well as the network interface of FIG. 18 corresponds to the basic structure of FIG. 12 and FIG. 16. However, while the IP block comprises S-type port controlling units OPCU, IPCU the network interface comprises P-type port controlling units IPCU, OPCU.

FIG. 19 shows a more detailed block diagram of a network interface of FIG. 17. The network interface comprises one demand-driven interface and a demand-driven interfaces which are implemented as S-type port and D-type ports, respectively.

FIG. 20 shows a block diagram of an implementation of a unidirectional channel between two locally synchronous islands (LSM1, LSM2) according to a seventh embodiment. The connection between the output port controllers OPCU and the input port controller IPCU is established via the handshake signals Ap and Rp. The latche L on the data lines data1, data2 that are controlled by the handshake acknowledge signal Ap decouple the communicating modules LSM1, LSM2 as much as possible.

Here, a S-type port is used for the output and input port controllers OPCU, IPCU for a locally synchronous island LSM1, LSM2 that is running at a clock that can not be stopped. Such a clock is typically an externally generated clock. Such locally synchronous island LSM1, LSM2 does not have a pausable clock generator PCG). The locally synchronous island LSM1, LSM2 can enable the S-type port (by toggling the En signal) to perform a data communication. When the signal Ta toggles—in turn—the data communication has been performed. The implementation of a S-type port is basically a free-running P-type port as the S-type port does not interfere any clock. A flip-flop FF is used to make signal Ta synchronous to the LSM clock signal. Therefore, instead of clock-synchronization which is employed by the P and D type ports, a data-synchronization is employed.

FIG. 21 shows a representation of the timing signals for an event driven synchronization. The clock C as shown in FIG. 21 is generated by a delay line and invertor DLI. If an event E1 arrives well before the clock edge, the clock C is not delayed as a mutual exclusion unit mutex receives the event and the clock edge sufficiently far apart (an event has taken place in minimal (constant) time) to avoid a metastabiliy. Only when the incoming event E2 arrives close to the clock edge (at the same time, in the limit) does the mutual exclusion element need to arbitrate who came first (or who is allowed to pass first in the case of strict coincidence). This may take some time (due to metastability), and may therefore delay ED the clock, i.e. the second event in FIG. 14. This happens rarely. The time between the moments at which the clock is delayed can be computed and depends on the clock speeds of the IP and NI (and reduces with higher speeds).

The response path works in a similar way. The request and response path are implemented in this way to ensure that the NI is pausable (i.e. its local clock can be stopped), but for a short time only. Note that the NI alone is stopped, clocks of any attached routers are not stopped, only their demand-driven handshakes may take a little longer. If a NI that is stopped for a short time, is attached to a fast router (e.g. due to process variation, or temperature differences) the momentary stalling of the NI may be compensated for by the router. In this way, a distributed asynchronous network on chip NOC can cope better with pausing than a globally clocked synchronous network, where all any delay incurrent due to a stalled NI cannot be made up for any more. This affects the latency only, not the throughput, which is always reduced to the slowest feedback loop.

If we consider the delays of the clock due to incoming events as errors, then, in contrast to the data-driven synchronization case, described above, these errors do not add up. That is, if multiple NIs are delayed at the same time, then the network on chip NOC as a whole will be delayed only by the worst of these delays, not the sum of the delays. This is an advantage of the event-driven synchronization scheme over the data-driven scheme.

If we over dimension the NI speed for example by 5%, then the mean time between failure for a single clock period is reduced, because 5% additional time for the mutual exclusion element mutex is available to settle. If multiple successive clock periods (for example 3) is considered, then the probability that the NI is too slow after 3 clock periods, is lower than the probability that the NI is too slow after 1 clock period, because if one delaying event occurs in the 3 clock periods, it has 3×5% slack to settle, instead of just 5%. Similarly for two delaying events during 3 periods (they each have 1.5×5% slack). For three delaying events, no additional slack is available. This is an advantage of the event-driven synchronization scheme over the data-driven scheme.

Accordingly, the physical (timing and clocking) aspects of networks on chip NOCs are relaxed: there needs to be no global clock for the network on chip NOC. The networks on chip NOCs are better scalable in terms of number of components, and hence performance. The IP and network on chip NOC can run at any independent speeds, (for event-driven IPNOC synchronization) without fear of incorrect data but with an a priori known mean time between failure in terms of missing time deadlines.

On the other hand, the testing of asynchronous circuits is harder than for synchronous circuits. The standard hardware backend flow (synthesis, timing verification, etc.) is more adapted to synchronous instead of asynchronous designs.

FIG. 22 shows a network on chip coupling several IP blocks according to a sixth embodiment. The communication between the network interfaces and the router as well as the inter-router communication is based on D-type interfaces with D-type ports, i.e. the interfaces between the components of the network on chip are demand-driven. The interfaces between the respective IP blocks and their associated network interfaces show interfaces according to the third (left), fourth (middle) and fifth (right) embodiment. Accordingly, the interfaces according to the third, fourth and fifth embodiment can also be applied in a single network on chip.

In a network on chip NOC based on the introduced GALS technology according to a fifth embodiment. To implement demand-driven communication between NOC and IPs, D-type ports are used at both sides of the channels between NIs and IPs. Since all channels use the D-type kind of ports, coherent progress of all blocks is guaranteed. Since D-type ports are 100% deterministic, the resulting amount performance is as well.

Other methods (from general networks) for providing QoS are known in the literature (in particular, rate-controlled schemes as described by H. Zhang. Service disciplines for guaranteed performance service in packet-switching networks. Proceedings of the IEEE, 83(10):1374-96, October 1995, and dead-line based schemes as described by J. Rexford. Tailoring Router Architectures to Performance Requirements in Cut-Through Networks. PhD thesis, University of Michigan, department of Computer Science and Engineering, 1999, but no networks on chip NOCs have been reported that implemented these schemes. These methods rely on a global notion of synchronicity, also.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim in numerating several means, several of these means can be embodied by one and the same item of hardware. The mere fact that certain measures are resided in mutually different dependent claims does not indicate that a combination of these measures cannot be used to advantage.

Furthermore, any reference signs in the claims shall not be constitute as limiting the scope of the claims.

1. Electronic device, comprising:
a plurality of first shared resources (SR1-SR4); and
a plurality of arbiter units (AAU1-AAU4) each for performing an arbitration for at least one of the plurality of first shared resources (SR1-SR4);
wherein communication between the arbiter units (AAU1-AAU4) is performed on an asynchronous basis, and data communication between first shared resources is performed on an asynchronous basis; and
wherein each arbiter unit (AAU1-AAU4) is adapted for sending a first token (T) to at least one neighboring arbiter unit (AAU1-AAU4), and for receiving a second token (T) from at least one neighboring arbiter unit (AAU1-AAU4) to implement a first global notion of time.

2. Electronic device according to claim 1, wherein
the arbiter units (AAU1-AAU4) are adapted to send and receive the first and second tokens (T) to implement a global arbitration scheme for providing a required end-to-end quality of service for all of the first shared resources (SR1-SR4).

3. Electronic device according to claim 1, further comprising
a plurality of ports (OPCU, IPCU);
an asynchronous interconnect means (IM, NOC) being a first shared resource (SR1-SR4) for coupling the plurality of ports (OPCU, IPCU);
wherein the interconnect means (IM, NOC) comprises a plurality of interconnect units (NI, R) each being a second shared resource, and a plurality of arbiter units each for performing an arbitration for at least one of the plurality of second shared resources and for sending a first token (T) to at least one neighboring arbiter unit, and for receiving a second token (T) from at least one neighboring arbiter unit to implement a second global notion of time within the interconnect means (IM, NOC).

4. Electronic device according to claim 3,
the arbiter units serve to implement a global arbitration scheme for providing a required end-to-end quality of service between the plurality of ports.

5. Electronic device according to claim 1,
wherein at least one of the first shared resources (SR1-SR4) is a communication resource, a storage resource, and/or a computation resource.

6. Electronic device according to claim 1, wherein
arbiter units (AAC1-AAC4) perform based on a Time Division Multiple Access scheme, based on a rate-controlled arbitration or based on a dead-line arbitration.

7. Electronic device according to claim 1, wherein
the arbiter units (AAC1-AAC4) or the first and/or second shared resources (SR1-SR4) comprise D-type ports.

8. Electronic device according to claim 1, wherein
the arbiter units (AAC1-AAC4) or the first and/or second shared resources (SR1-SR4) comprise P-type ports.

9. Electronic device according to claim 1, wherein
the arbiter units (AAC1-AAC4) or the first and/or second resources (SR1-SR4) comprise S-type ports.

10. Electronic device according to claim 3, wherein
the interconnect unit (NI, R) is a second shared resource and comprises network interface (NI), routers (R), bridges, and/or busses.

11. Electronic device according to claim 1, wherein at least one of the first shared resources comprise network interface (NI), routers (R), bridges, and/or busses.

12. Electronic device according to claim 1, wherein
one of the first shared resources is a memory and the arbiter unit is a memory controller.

13. Electronic device according to claim 1, wherein
one of the first shared resources is a computation unit and the arbiter unit is a task scheduler for hardware or software multi-threading.

14. Electronic device according to claim 3, wherein
the first and second global notion of time are the same

15. Electronic device according to claim 3, wherein
the second global notion of time is multiple or divisor of the first global notion of time.

16. Electronic device according to claim 1, wherein
the first and second token (T) indicate the passing of logical time based on non-zero increment, the increment being static or dynamically varying.

17. Electronic device according to claim 1, wherein
the data communication is combined with a synchronization communication.

18. Method for arbitrating shared resources within an electronic device having a plurality of first shared resources by performing a plurality of arbitrations for at least one of the plurality of first shared resources, comprising the steps of:
sending a first token to at least one neighboring arbitration, and
receiving a second token from at least one neighboring arbitration to implement a first global notion of time;
wherein communication between arbitrations is performed on an asynchronous basis, and wherein data communication between shared resources is performed on an asynchronous basis.

19. (canceled)
